(19) United States
(12) Patent Application Publication
(10) Pub. No.: US 2010/0127410 A1
(43) Pub. Date: May 27, 2010

(54) METHOD AND DEVICE FOR THE METERED RELEASE OF IRRITANTS

(76) Inventor: Karl-Heinz Dräger, Berlin (DE)

Correspondence Address: WEINGARTEN, SCHURGIN, GAGNEBIN & LEBOVICI LLP, TEN POST OFFICE SQUARE, BOSTON, MA, 02109, US

(21) Appl. No.: 12/598,463

(22) PCT Filed: Apr. 30, 2008
(86) PCT No.: PCT/EP08/03529

§ 371 Date: Dec. 4, 2009

(30) Foreign Application Priority Data
May 3, 2007 (DE) 10 2007 021 267.6

(51) Int. Cl. F02M 27/04; E04H 9/10

(52) U.S. Cl. 261/1; 109/1 R

(57) ABSTRACT

The invention relates to a method and a device for the metered release of irritants by means of a propellant and/or solvent gas in anti-people defense rooms. The invention describes a method and a device for a metering controller for releasing irritants by means of a propellant and/or solvent gas in anti-people defense rooms while complying with health limits. After a first dose (T_{E}), subsequent dosages (T_{N}) are carried out in time intervals, so that both a hazardous limit of a concentration of the irritants in the room (1) is not exceeded and that also a sufficiently effective concentration is always met, and the concentration-lowering losses (S_{F}, S_{V}) arising from the agent, system and environment are compensated for. The concentration losses are detected metrologically and/or as parameter-dependent variables (S_{F}, Sᵥ) and made available as a program solution of the control device (7).

### BACKGROUND OF THE INVENTION

1. Technical Field

The present invention concerns a method of and a device for the metered release of irritants by means of a propellent gas and/or solution gas by irritant spray installations or irritant nebuliser installations upon use in rooms for non-injuring anti-personnel defence.

The term irritants is used to denote substances which produce an irritation on human beings or animals in given metered amounts, without in that respect causing permanent health damage. In that case the irritant effect is dependent on the acting concentration and nature of the irritant. Metering of the substances is crucial in terms of whether an injuring effect or a fatal effect occurs.

The metering control according to the invention relates to irritants which act primarily by way of the skin, in particular the mucous membrane and respiration, without being restricted to that kind of irritants.

In that respect it is immaterial whether the irritants in question are synthetic substances (for example CS) or naturally occurring substances (for example OC) or a combination of synthetic and natural substances.

2. State of the Art

Irritants are used for anti-personnel defence as non-lethal active agents, for example in regard to burglary protection for enclosed rooms. In that case an irritant is expelled with a propellent gas and/or solution gas for very fine distribution into the room air. In addition irritant spray installations are also known, which mechanically atomise by pumping or gas loading (propellent gas) through nozzles.

DE 44 24 772 A1 describes an automatic irritant gas spray installation for alarm systems, in which a flask is mechanically opened so that irritant gas issues directly therefrom into the ambient air.

DE 202 01 265 U1 discloses an automatic CS gas nebulisation arrangement in which an irritant gas issues from a supply container by way of a short nozzle and an irritant gas/air mixture is expelled into the ambient air by a fan.

In DE 299 23 948 U1 describing a device for restraining criminals the irritant gas is discharged directly from a supply flask into the ambient air.

EP 0 524 313 B1 sets forth a spray agent distribution system for atomising ingredients in large spaces.

In addition EP 0 425 300 B1 describes a metering and discharge system for spraying an active substance (insecticide). The propellent agent (preferably carbon dioxide) is to pass in the fluid state into the conduit system and mixed with the active substance by way of a mixing loop. That system is not suitable for spraying an irritant.

Finally DE 10 2006 016 286 A1 discloses a method and a device with which solid or liquid irritants or warfare agents are finely distributed by way of a conduit system in large indoor or outdoor regions, for anti-personnel defence purposes.

In accordance with the present day state of the art no irritant spray installations or irritant nebulisation installations are known, in which an optimum concentration of the irritant in a room can be achieved and maintained over a prolonged period of time.

### SUMMARY OF THE INVENTION

The object of the invention is to provide a method of and an apparatus for metered release of irritants by means of a propellent gas and/or solution gas in rooms for anti-personnel defence in relation to automatic or semi-automatic release installations while complying with health limit values, with which the highest effectiveness of the irritant with the exclusion of health damage and a predetermined concentration of irritants are maintained in the room air over a prolonged period of time.

That object is attained by a method comprising the features of claim 1 and an apparatus comprising the features of claim 8. Advantageous developments and configurations are subject-matter of the respective appendant claims.

In human beings irritants act on sensory, that is to say sensitive nerve ends in the skin and mucous membrane, in particular of the eye and the respiratory tracts. Depending on the concentration acting on the person, the consequences are tears and nasal flow, difficulties with breathing as far as stoppage of respiration, skin irritations to the extent of skin burns and the like.

Therefore the basic starting point of the invention is that health damage in the release of irritants in rooms can be avoided only if the amount of irritant is liberated in a metered fashion below the amount which is safe in terms of health and which does not cause permanent damage, in relation to the room volume.

The health limit value dependent on the nature of the irritant used is specified in mg per m³ of room air. It corresponds to the amount of irritant concentration at which a healthy human can remain there without permanent damage. That limit value is to be observed to avoid health damage.

A high level of effectiveness in anti-personnel defence in rooms is only achieved if the liberated amount of irritant is close to the limit value which is safe in terms of health and is maintained over the desired defence period (protection period).

Should it be appropriate or necessary to release smaller amounts of irritant and to adapt such amounts to the requirements involved, that is equally possible with the method described here. Such a requirement which differs from the maximum value could be for example statutory requirements, early-warning releases, safety reserves and so forth.

The present invention is based on the realisation that in regard to the release of irritants in the civil area of use of object protection it is necessary to provide metering in regard to the (first) release so as to ensure that the concentration of the irritants does not exceed a health-endangering level.

The inventor further realised that, to maintain an optimum concentration amount of irritants in a room, over a prolonged period, it is necessary to compensate for discharge losses as occur for example due to air interchange in respect of irritant-bearing room air, deposit of irritants and hydrologisation of irritants, after a released, room volume-related initial metering.

For that purpose if the concentration falls below a predetermined level irritant has to be released again until the maximum permissible concentration value of irritant is regained in the ambient air. The concentration losses due to substance, installations and environment are therefore made available to a metering control in order to maintain a given irritant concentration over the period of first release, by controlling the discharge device.

The invention therefore provides a method of and a device for metering control for complying with health limit values when releasing an irritant in rooms for anti-personnel defence, in which the irritant contained in a propellent gas and/or solution gas is discharged by means of a release device or directly from a pressurised storage container by way of a conduit system and at least one valve-controlled outlet opening.

By way of a control, the irritant is released by parameter-dependent influencing factors which can be governed both by substance and installation and also by environment, over a first time interval for first administration, wherein the length of the time interval is determined by a maximum permissible value which excludes a health-damaging effect. In the further course of the procedure post-metering is effected over one or more time intervals to compensate for losses due to substance, installation and environment, wherein the majority of influencing factors are predetermined and/or can be calculated and preferably only temperature (and possibly also air motion) is measured as a variable value which determines the pressure of the propellent gas, for metering control.

The above-specified influencing factors governed by the substance involved predominantly concern the irritant.

If suitable sensors should be made available, then besides the parameter-dependent metering control it is also possible for the irritant concentration in the room to be measured directly and for that measurement value to be used in the installation as a control value for regulated metered release.

In addition a prerequisite for that purpose is uniform very fine distribution of the irritant in the room and a reliable and unimpeded mode of operation for the irritant sensors.

The losses caused by the substance involved and the environment are determined for example by the following influencing factors:
room size in m³,
kind of irritant and the limit values which are safe in regard to health and which are respectively predetermined therewith, in mg/m³,
irritant concentration in the solution gas or solvent in mg/ml,
kind of propellent gas, characterised by the specific temperature pressure (in which respect the propellent gas can also perform the solution gas function),
admixture, emulsion and solution concentration of propellent gas-solvent-irritant in mg of irritant per volume or percent of solution,
half-life time, caused by hydrologisation (if it occurs) in amount/time,
pressure fluctuation of the propellent gas, caused by temperature fluctuation of the propellent gas, and different discharge amounts linked thereto in the same unit of time in bars per ° C.,
deposit loss due to settlement of the irritant out of the room air in amount/time, and
ventilation loss due to the discharge of enriched room air amounts in amount/time, for example from adjacent rooms or outdoors, due to air conditioning installations, garage ventilation slots and so forth.

The installation-governed influencing factor ‘through-flow amount per time’ at the outlet opening is involved as a fixed value in the calculation of the initial administration and post-metering. The through-flow level can possibly also be altered and controlled.

Control of the influencing factors is so influenced by the method and the devices operating in accordance with the method that, in relation to anti-personnel defence by means of irritant release installations, in the release situation, a limit value in respect of the irritant concentration, which is not harmful to health, is not exceeded in the room air. At the same time the maintenance of an effective concentration near to the limit value which is not harmful to health is ensured over a period of at least 20 minutes so that effective anti-personnel defence is possible without injuring the person.

In that respect, in a first release, independently of the irritant supply in the storage container, the amount of irritant to be released is only such as to give a predetermined concentration value in the room air.

The maximum non-injuring amount of irritant gas for a room in which defence is to be presented to one or more persons is calculated by multiplying the irritant-dependent limit value or presetting value by the room volume as the initial irritant release amount (for example for CS=2 mg/m³). It is predetermined for example for CS irritant by the IDLH value.

IDLH (immediately dangerous to life and health) is a concentration of a substance, defined by the US Occupational Safety and Health Administration (OSHA) and the National Institute for Occupational Safety and Health (NIOSH) in the framework of a concept for assessing accidents. In accordance with that concept it should be possible in the event of exposure up to the level of the IDLH to flee, even if a respirator fails, without suffering life-threatening or other severe health effects in the event of exposure to that substance, which lasts for up to 30 minutes. This can also involve other international or national regulations which for the avoidance of injury to health lay down limit values for irritants in action concentrations and also under some circumstances with action times, which serve as a maximum limit value.

Therefore the expression first release amount is used to denote the highest permissible or predetermined amount of irritant which is necessary for irritant release for the total room volume for first defence against persons.

In contrast thereto is the post-metering amount which is adjusted in accordance with a given period of time, the concentration hold time, by virtue of irritant deposit, air circulation loss and irritant hydrologisation in order to regain the first release concentration. For safety reasons it is desirable for the value to be below the maximum permissible value. In release of CS irritant, good defence properties were established even with levels of concentration lower than the maximum permissible values.

To achieve the greatest effectiveness without bodily injury in anti-personnel defence in rooms, for example when using CS irritant, a room concentration of below 2 mg/m³ should be released and maintained over a period of at least 20 minutes.

Commercially available irritant spray cans in terms of their content only extremely rarely correspond to the required and admissible amount for a given room volume.

Their contents of active substance are randomly established and bear no relationship to the room volume of the place of release. When a commercially available irritant spray can is emptied in rooms, that can result both in exceeding the concentration which is a danger to health and also involve the concentration being below the appropriate value, so that it is ineffective. Apart from that release is often directed directly towards the person so that this can involve locally different endangerment values. To minimise or exclude the concentration being exceeded at points, the irritant gas release installation to be controlled or regulated must have a sufficiently widely branched discharge system which permits homogeneous distribution.

Preferably control for metering the administration of irritant to the room air is effected by way of a time control of an irritant outlet valve.

In addition it is also possible to control the discharge amount at the outlet opening, by narrowing or enlarging it.

The concentration and amount of irritant solution can be fixed by the supplier of commercially available irritant containers or can be definedly admixed.

Likewise the propellent gas and/or solution gas and under some circumstances the added solvents and/or emulsifiers is known in respect of its or their chemical compositions and physical properties. Temperature and pressure of the propellent gas and the size of the conduits, valves and nozzles are known or can be measured or calculated, with their through-flow amounts.

It is possible to calculate from those values or to ascertain from tests, how much irritant is released in a unit of time, for example in seconds (mg/s) from a storage container, to achieve a desired irritant concentration.

Controlling the irritant release valve by way of a time control, for example time relays, a processor or a timing clock etc defines the opening time of the irritant release valve to afford the release amount corresponding to the room volume below the limit value which is not harmful to health.

That kind of release which releases the maximum permissible amount of irritant in relation to the room volume at the beginning of the defence procedure is generally taken to mean the process of first administration.

After the irritant has been released the respectively prevailing influencing factors such as irritant deposit, ventilation loss, for example due to leakage from the rooms and hydrologisation of the irritant begin to act. If that is not counteracted, the released irritant concentration is reduced in dependence on its time of action, until it becomes ineffective.

To achieve effective room protection and thus anti-personnel defence over a longer period of time the irritant concentration losses in the room air must be compensated by a supplemental release after a given time, the blocking time, by release of a post-metering amount.

The term supplemental release is used to denote the release of a precise amount of irritant which compensates for the irritant loss which has occurred in the time from first release to the supplemental release. It serves to attain the irritant concentration of the first release in the room air in order thereby to regain the defence effect to the same strength as the first release.

The supplemental release involves fixing the supplemental amount which is compensated after a given period of the concentration hold time due to irritant deposit, air circulation loss and irritant hydrologisation to regain the first release concentration.

The deposit losses of irritant in a unit of time are known as a physical parameter, they are for example in the case of CS 33% of the release amount, within 2 hours that is 0.275% per minute.

The ventilation loss is to be estimated or ascertained in terms of building physics. It is involved in the calculation of the post-metering amount with a loss (mg/m³) per unit of time, in terms of the post-metering amount.

In that respect the unit of time is the time which has elapsed between the first metering until the moment of post-metering.

The hydrologisation of irritant which involves many kinds of irritant is involved in the post-metering with its half-life time, for example 14 minutes in the case of CS, in relation to the moment in time of post-metering.

The moment in time of the post-metering amount and the post-metering moment in time is afforded in dependence on the magnitude of the influencing factors and the required defence effectiveness with a required concentration below the non-lethal and thus permissible concentration as a maximum amount and the required strength of effect, consequently the minimum concentration.

The period of time between the first release and post-metering is the blocking time in which the time relay is blocked for triggering. It begins after release of the first triggering amount and ends at the moment in time of the post-metering, at which release of the post-metering amount begins. The post-metering time is reached when the influencing factors have reduced the irritant concentration to such an extent that the lower limit of the desired effectiveness and the concentration linked thereto is reached.

Consequently the post-metering time is the time in which the irritant release valve is opened for post-metering. It remains open as long as is required for release of the post-metering amount.

If the propellent gas containers in the case of mixing installations or the storage containers with propellent gas solvent and irritant are disposed in rooms with temperature fluctuations, the discharge amount changes in relation to the unit of time, as a consequence of the variation in the propellent gas pressure.

That pressure-induced variation in discharge can be ascertained in relation to propellent gas or solution gas, in so-called pressure-temperature graphs which are known for the kinds of gas.

The pressure rises with increasing temperatures and the pressure falls with falling temperatures. The release amount thus rises or falls in the same unit of time.

Those processes are compensated by actuation of a temperature measuring device for influencing the time control. The opening times for the irritant valve are shortened or lengthened in accordance with the variations in temperature.

In the case of heat the opening time is shortened and in the case of cold it is prolonged so that accordingly the first release and post-metering values are achieved independently of temperature-induced variations in pressure.

Another possibility involves compensating for the variation in temperature and the variation in pressure linked thereto and the variation in discharge by using a bimetal member or liquid thermostat in the conduit system or in the outlet opening to thermodynamically change it.

The liquid thermostat or the bimetal member in that case automatically reduces the maximum cross-section required at the lowest temperature for the necessary release action. The through-flow of irritant is so reduced upon an increase in temperature and pressure that the through-flow amount which is increased by the rise in pressure is compensated.

In that respect it is to be structurally established that the maximum opening cross-section of the thermostat is less than the opening cross-section of the opening valve or the outlet opening.

A further advantageous solution suitable for example for mobile irritant/irritant gas release installations involves control of the discharge amount of irritant/irritant gas by an irritant sensor. In the first release and in post-metering one or more irritant sensors apply their correction signal to the control unit if the desired value or the limit value or the limit value in respect of health is reached in the air to which irritant is to be administered.

With this mode of operation differences in distribution discharge amounts must be compensated by ongoing measurements of the concentration of irritant in respect of the room air and programming in the processor. Such distribution differences occur upon first release and post-metering until the irritant is relatively homogeneously distributed in the room air from the discharge opening. The use of a plurality of irritant sensors and network programming makes it possible to achieve relatively homogeneous distributions of irritant.

In contrast to the above-described invention the conventional irritant spray installations and irritant nebuliser installations referred to in the opening part of this specification leave the size of the room out of consideration upon irritant release, that is to say that involves mere and thus random release of the irritants. In the case of irritant release which does not take account of the room volume however there are on the one hand the risk of exceeding the limit values with the result of damage to health and on the other hand the risk of the concentration being below the desired level, with the consequence of the installation being ineffective. The conventional installations are therefore basically not suitable for anti-personnel defence in rooms. Likewise with the known installations the influencing factors governed by substance, installation and environment on the concentration of an irritant in a room are disregarded.

The method according to the invention and the device according to the invention therefore differ from the conventional systems by the provision of a metering action in the first release and also by post-metering procedures—in contrast to a mere one-off release of irritants, with the above-described problems.

### BRIEF DESCRIPTION OF THE DRAWINGS

The mode of operation of the invention is described in greater detail with reference to drawings in which:

FIG. 1 shows the basic mode of operation of the metering control installation with processor and thermosensor, and

FIG. 2 shows the mode of operation of the control with processor and thermostat.

### DETAILED DESCRIPTION OF EMBODIMENTS PREFERRED AT THE PRESENT TIME

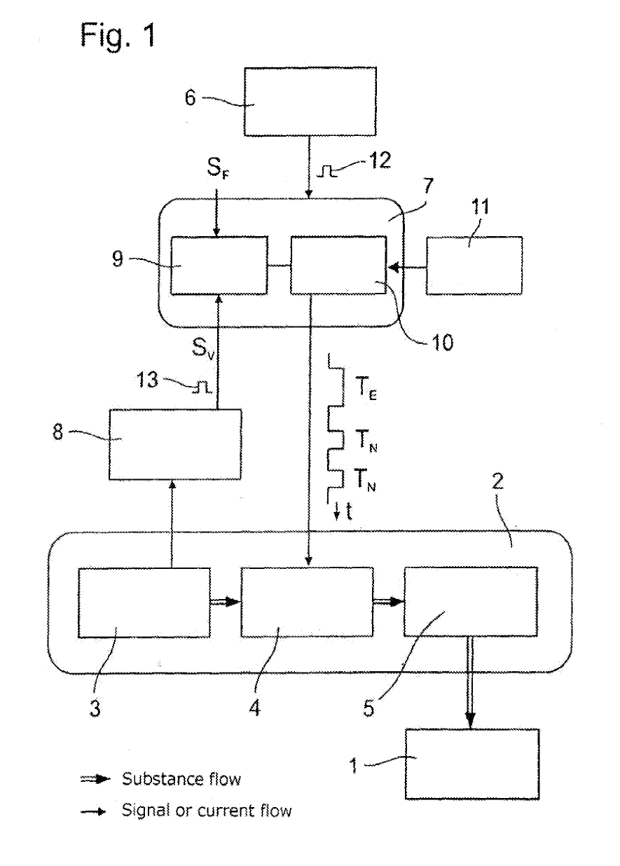

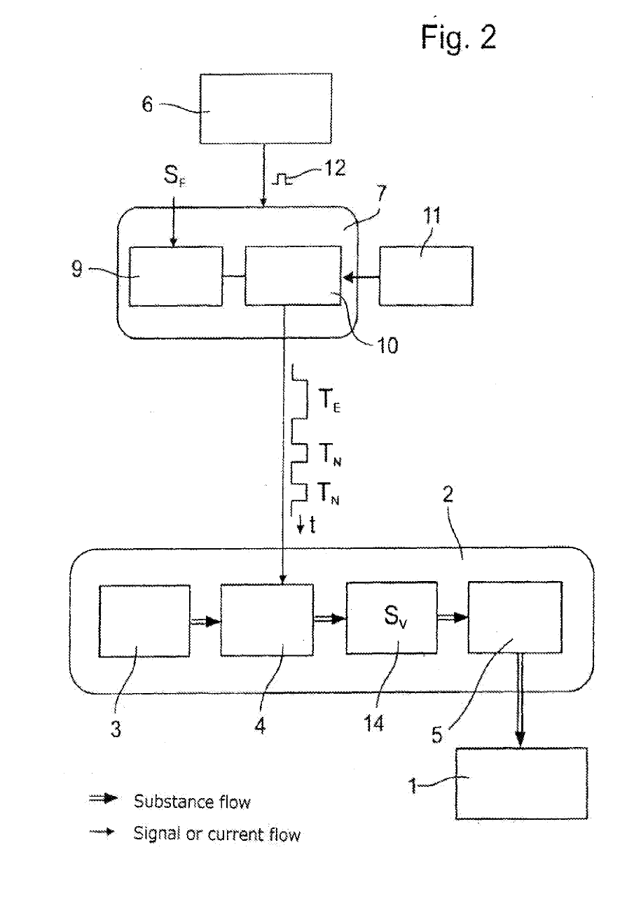

The example is described by reference to the use of a CS irritant in FIGS. 1 and 2. It is however also possible to use all other kinds of irritants and irritant gases.

In the release of CS irritant as a non-lethal, non-injuring effective agent (non-lethal weapons) for anti-personnel defence within rooms 1 only a metered amount of CS irritant may be released, which excludes damage to health.

At the same time, to achieve a high level of effectiveness in terms of defence, levels of concentration which are predetermined or as high as possible must be released.

The limit value at which a person can be exposed to the effect of CS for 30 minutes without damage to health is for example a concentration of 2 mg/m³ CS irritant in the room air, in accordance with the IDLH value. In the case of unmetered release of CS from a storage container, depending on the respective storage amount and room size, the anti-personnel defence may be ineffective or may cause injury, just the metering of CS alone as a proportion of the room air is crucial.

To achieve a defence effectiveness which is as high as possible over a longer period of time the CS irritant concentration must be close to the limit value and must be held there. That is in conflict with the hydrolysis of CS with air humidity, which leads to the substances o-chlorobenzaldehyde and malonic acid dinitrile which are ineffective in terms of defence. In that respect the half-life time is about 14 minutes.

To maintain the predetermined CS concentration after a first release T_{E} over a longer period of time a post-metering T_{N} is required, which compensates for the hydrologisation loss.

The use of propellent and/or solution gases for release and very fine distribution of CS irritants means that the release amounts change in accordance with the variations in temperature of the gases and the resulting variations in pressure thereof.

As a consequence of the temperature-induced fluctuation in pressure the discharge amount of the added CS irritant also changes within the same release period.

At high temperatures with high gas pressures and high discharge speeds the limit value of 2 mg/m³ can be exceeded. At low temperatures the discharge amount can be too low to be effective.

To achieve effective anti-personnel defence it is therefore necessary for the concentration of CS irritant to be held at the limit of 2 mg/m³ or another predetermined concentration over a longer period of time without exceeding it.

A sufficient amount of irritant to defend against intruders is discharged with a spray device 2 into a room 1 and maintained over a prolonged time, for example 30 minutes.

The spray device 2 comprises a storage container 3 comprising a compressed gas bottle or a storage container in a distribution installation, in which the irritant is supplied to one or more outlet nozzles 5 by way of a valve 4. The valve 4, for example a solenoid valve, is controllable. It is however also possible to control the through-flow amount and/or the opening of the outlet nozzle 5.

If a light barrier arrangement etc is triggered by a sensor 6, for example a burglary signalling device, then a control unit 7 is activated by way of an actuation signal 12. The unit 7 then controls the valve in dependence on fixed values S_{F} and variable values S_{V}. In the FIG. 1 embodiment control is effected exclusively in relation to the time t in which the valve 4 opens and closes.

In a first time interval T_{E} for the first release the room 1 receives a predetermined defence dose.

In dependence on various influencing factors the dose falls and after a given time t post-metering has to be effected in one or more time intervals T_{N}.

The influencing factors are both governed by substance and installation and also induced by environmental influences.

Influencing factors governed by substance and installation are for example:
kind of irritant
irritant deposit
irritant concentration
hydrologisation of irritant
release amount per unit of time.

Influencing factors governed by environment are for example:
room size
temperature of the propellent gas and evaporation pressure linked thereto
air movement through room openings.

For control purposes the influencing factors are divided into control values S_{F} which can be fixedly preset and variable control values S_{V} which can change during operation.

The variable values S_{V} include temperature and air movement, in which respect it is sufficient to measure only temperature by way of a thermosensor 8, that then being applied to the control unit 7 as a correction signal 13. Possible air movement can be calculated on the basis of structural engineering and is to be taken into account as a fixed value for the respective installation.

If an air conditioning and ventilation installation should be installed in the room 1 to be contaminated, in which the room air is exchanged at given spacings by a fan, that air exchange can additionally be taken into consideration as a control value S_{V} for the control unit 7 (for example a flow is or is not flowing through the fan).

The control values S_{F}, S_{V} are detected and evaluated by way of a computer 9. The computer 9 establishes the necessary times T for the first metering T_{E} and the post-metering T_{N} and a timer 10 controls the valve 4.

The necessary power is fed to the metering control system by way of a power supply 11.

Instead of the thermosensor 8 FIG. 2 uses a thermostat 12 in the conduit system of the spray installation 2, for increasing or reducing the through-flow amount as a consequence of the temperature-induced fluctuation in pressure.

All other influencing factors are controlled by way of the control unit 7 by opening and closing the valve 4 in dependence on time.

### LIST OF REFERENCES

1 room
2 discharge device
3 storage container
4 controllable valve
5 outlet opening
6 triggering sensor/triggering device
7 control unit
8 thermosensor
9 computer
10 timer
11 power supply
12 switch-on signal
13 correction signal
14 thermostat

1. A method of metered release of irritants by means of a propellent gas and/or solution gas in rooms for anti-personnel defence, in which the release of irritants is so controlled that after a first metering (TE) post-meterings (TN) are effected at time intervals so that both a health-endangering limit value of a concentration of the irritants in the room is not exceeded and also the concentration is not below a sufficiently effective concentration and the concentration-reducing losses (SF, SV) governed by the substance, installation and environment are compensated.

2. A method according to claim 1 characterised in that the concentration losses are ascertained by measuring technology and/or in the form of parameter-dependent values (SF, SV) and are made available as a program solution of a control device.

3. A method according to claim 2 characterised in that the parameter-dependent values (SF, SV) are ascertained from the kind of irritant, the irritant concentration, the irritant deposit, hydrologisation, the release amount per unit of time, the room size, the temperature of the propellent gas and/or the air movement in the room.

4. A method according to claim 1 characterised in that the temperature of the propellent gas is incorporated into the program control as a constantly changing measurement value (SV).

5. A method according to claim 1 characterised in that air exchange between the room and the surrounding air, which takes place through openings or by diffusion, is incorporated into the program control as a constantly changing measurement value (SV).

6. A method according to claim 5 characterised in that the air movement is determined by way of the air flow of a fan in an air conditioning and ventilation installation.

7. A method according to claim 5 characterised in that the air movement is ascertained by building physics or by a test.

8. A device for metered release of irritants by means of a propellent and/or solution gas in rooms for anti-personnel defence, having a discharge device comprising a storage container, a conduit system and at least one outlet nozzle actuable by way of a switchable valve, wherein
there is provided a control device having a computer and a timer for implementing an optimum irritant concentration in a room on the basis of measurement- and parameter-dependent values (SF, SV) of the spray device;
the discharge device includes a temperature measuring device for continuously detecting the temperature of the propellent gas; and
the measurement- and parameter-dependent values (SF, SV) which are processed by program technology in the computer can be fed to the timer and can be fed in the form of time intervals (TE) and (TN) to the valve for the control of opening and closing cycles.

9. A device according to claim 8 characterised in that the discharge device comprises a mixing installation for liquid gas as solvent and propellent gas and solvent and irritant in solution or a compressed gas bottle with a propellent gas solvent mixture and irritant in solution.

10. A device according to claim 8 characterised in that a thermostat is arranged in the conduit system of the spray device upstream of the outlet opening for temperature-dependent control of the through-flow of irritant.

11. A device according to claim 10 characterised in that the through-flow of the outlet opening is variable in dependence on the temperature and the variation in pressure linked thereto of the propellent or solution gas.

12. A device according to claim 10 characterised in that the discharge amounts which differ in dependence on the temperature and the variation in pressure linked thereto can be compensated by adaptation of the opening times of the release valve.

13. A device according to claim 10 characterised in that a pressure reducing device is provided to compensate for the temperature-induced variations in pressure of the propellent and/or solution gas to achieve equal discharge values.

14. A device according to claim 8 characterised in that an irritant concentration sensor is arranged to ascertain the irritant concentration.

15. A method according to claim 1 characterised in that:
the concentration losses are ascertained by measuring technology and/or in the form of parameter-dependent values (SF, SV) and are made available as a program solution of a control device;
the parameter-dependent values (SF, SV) are ascertained from the kind of irritant, the irritant concentration, the irritant deposit, hydrologisation, the release amount per unit of time, the room size, the temperature of the propellent gas and/or the air movement in the room;
the temperature of the propellent gas is incorporated into the program control as a constantly changing measurement value (SV); and
air exchange between the room and the surrounding air, which takes place through openings or by diffusion, is incorporated into the program control as a constantly changing measurement value (SV).

16. A method according to claim 15 characterised in that the air movement is determined by way of the air flow of a fan in an air conditioning and ventilation installation.

17. A method according to claim 15 characterised in that the air movement is ascertained by building physics or by a test.

18. A device according to claim 8 characterised in that:
the discharge device comprises a mixing installation for liquid gas as solvent and propellent gas and solvent and irritant in solution or a compressed gas bottle with a propellent gas solvent mixture and irritant in solution;
a thermostat is arranged in the conduit system of the spray device upstream of the outlet opening for temperature-dependent control of the through-flow of irritant; and
an irritant concentration sensor is arranged to ascertain the irritant concentration.

19. A device according to claim 18 characterised in that the through-flow of the outlet opening is variable in dependence on the temperature and the variation in pressure linked thereto of the propellent or solution gas.

20. A device according to claim 18 characterised in that the discharge amounts which differ in dependence on the temperature and the variation in pressure linked thereto can be compensated by adaptation of the opening times of the release valve.

21. A device according to claim 18 characterised in that a pressure reducing device is provided to compensate for the temperature-induced variations in pressure of the propellent and/or solution gas to achieve equal discharge values.
